(19) United States
(12) Patent Application Publication
(10) Pub. No.: US 2007/0112652 A1
(43) Pub. Date: May 17, 2007

(54) Throughput accounting for professional, scientific and technical services

(76) Inventor: John A. Ricketts, Clarendon Hills, IL (US)

Correspondence Address: DILLON & YUDELL LLP, 8911 N. CAPITAL OF TEXAS HWY.,, SUITE 2110, AUSTIN, TX, 78759, US

(21) Appl. No.: 11/264,954

(22) Filed: Nov. 1, 2005

(51) Int. Cl. G07F 19/00

(52) U.S. Cl. 705/30

(57) ABSTRACT

A method, system and computer-usable medium that includes: inputting a Throughput (T), an Investment (I) and an Operating Expense (OE) into a Throughput Accounting logic to create performance measures, resource measures, decision support measures and control measures; storing the performance measures, resource measures, decision support measures and control measures in a database; and inputting queries and contents of the database into a decision support logic to create a supported decisions output.

### BACKGROUND OF THE INVENTION

1. Technical Field

The present invention relates in general to the field of computers and similar technology systems, and in particular to software utilized by such systems to implement methods and processes. Still more particularly, the present invention relates to a computer-implementable method and system for accounting in a Professional, Scientific and Technical Services enterprise environment.

2. Description of the Related Art

Within the North American Industry Classification System (NAICS), the Professional, Scientific, and Technical Services (PSTS) sector is unique because it's the only sector where: the primary output is services, but sales are made on expertise; workers are typically assigned to serve specific clients; the degree of customization for specific clients is very high; reliance on intellectual capital is very high; and repeatability of processes is relatively low. FIG. 1 presents a chart 100 that describes the unique features of the PSTS sector compared to other enterprise sectors.

The unique characteristics of PSTS require different management methods than the other sectors. For example, maintaining an expert workforce with dynamic work assignments and processes having limited repeatability requires different hiring, training, deployment, and assets.

Many PSTS management methods originated decades ago, yet are still relatively ad hoc, relying heavily on the independent judgment of partners, project managers, resource managers, and practitioners. Consequently, their decisions are not inherently aligned, and so are not always able to cope well with global competition or enable business models for services on demand.

To compete effectively today, a PSTS firm must manage its own enterprise and individual projects well because clients have many options, both domestically and internationally. Providing services on demand is an emerging way to respond to dynamic client needs.

One aspect of the PSTS management problem not addressed by prevailing practice or previous method and systems is measurements that foster services on demand. Measurements are essential for effective management because they (a) communicate information used in decision making and (b) affect how people behave.

### SUMMARY OF THE INVENTION

Recognizing the shortcomings of the prior art, the present invention presents a method, system and computer-usable medium that includes: inputting a Throughput (T), an Investment (I) and an Operating Expense (OE) into a Throughput Accounting logic to create performance measures, resource measures, decision support measures and control measures; storing the performance measures, resource measures, decision support measures and control measures in a database; and inputting queries and contents of the database into a decision support logic to create a supported decisions output.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts a prior art matrix comparing Professional, Scientific and Technical Services to other enterprise fields:

FIG. 2 illustrates components of the overall system used by the present invention;

FIG. 3 illustrates an exemplary computer in which the present invention may implemented;

FIG. 4 depicts an exemplary server from which software for executing the present invention may be deployed;

FIGS. 5a-b show a flow-chart of steps taken to deploy software capable of executing the steps shown and described in FIG. 2

FIGS. 6a-c show a flow-chart of steps taken to deploy in a Virtual Private Network (VPN) software that is capable of executing the steps shown and described in FIG. 2;

FIGS. 7a-b show a flow-chart showing steps taken to integrate into an computer system software that is capable of executing the steps shown and described in FIG. 2; and

FIGS. 8a-b show a flow-chart showing steps taken to execute the steps shown and described in FIG. 2 using an on-demand service provider.

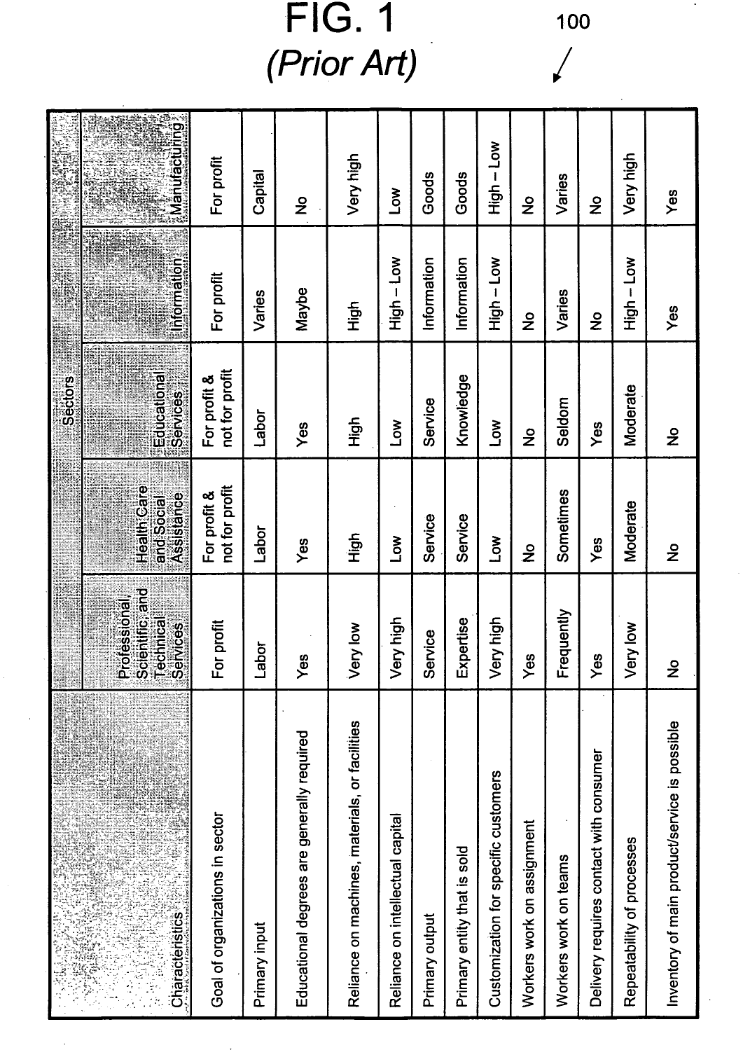

### DETAILED DESCRIPTION OF THE PREFERRED EMBODIMENT

Every enterprise operates within certain boundaries. If they didn't, they could grow indefinitely. Such boundaries generally show up as conflicts between opposing forces, and enterprises may oscillate between sides of the conflict. Conflicts addressed by the present invention include:

Capacity versus utilization—PSTS enterprises need adequate capacity to grow, but they also need high utilization (no unnecessary capacity) to maintain profitability. The prevailing practice is to adjust capacity according to long-range forecasts and annual plans, but it can be adjusted on demand using the present invention. However, that practice is often used by resource managers and monitored by partners, so it doesn't necessarily affect the decisions of project managers or behavior of individual practitioners.

Local versus global optimization—PSTS enterprises generally seek to optimize individual projects on the assumption that this is the best route to optimization of the enterprise. However, it's possible for individual projects to do well while the enterprise does poorly if it has excess capacity or it fails to invest sufficiently in systems, skills, intellectual capital, and assets that will sustain it in the future.

Cost versus revenue—PSTS enterprises have traditionally based their prices on billable hours (cost-plus pricing) because services are labor intensive. But as client needs become more strategic and as service providers develop reusable assets, value pricing becomes more attractive for both parties. And as project funding requirements rise and client risks increase, risk-reward sharing likewise becomes more attractive to both parties. There are, however, other issues. For instance, speed itself has value because a project completed early not only positions the provider to start another project, it starts the client's benefits sooner. Thus, interactions between cost, revenue, value, risk, and speed can be hard to quantify.

Investment versus delivery—PSTS enterprises must deliver services to generate revenue and profit, but they must also invest in skills and intellectual capital to maintain their expertise. Investments are rarely billable activities because their connection to sales and delivery is seldom direct. Thus, finding the right level of investment is more art than science, and natural forces tend to push against investments. That is, when demand is low and resources are available for training and intellectual capital development, pressure to contain costs is high. Conversely, when demand is high and resources have little time for training and intellectual capital development, investment funds are more readily available.

Troubled projects versus risk taking—PSTS enterprises strive to avoid troubled projects and rapidly turn around those that cannot be avoided because troubled projects generate losses and are more likely to create client dissatisfaction. Yet PSTS enterprises must take risks to win business, and those risks create the possibility that some projects will become troubled. Since it can take several profitable projects to recoup the loss on just one troubled project, managing risk and recovery is a critical success factor.

Role conflicts—Everyone employed within a PSTS enterprise is preferably measured on multiple criteria, including quality of deliverables, service level agreements, and client satisfaction. But the dominant measure for each specific role can put it at odds with other roles. For example, if partners are measured on revenue, project managers are measured on profit, resource managers are measured on skills, and practitioners are measured on utilization, various conflicts emerge. Partners can sell risky projects to attain revenue. Project managers can limit hours and expenses to protect profit. Resource managers can maintain a sizable bench to ensure skills are available. And practitioners can work as many billable hours as possible to attain individual utilization credit. However, even if workers in every role meet their primary targets, the enterprise as a whole may not perform as well as it could if the measurements were aligned.

Although every PSTS enterprise relies on measurements, there is no known scheme that addresses all conflicts listed above. On the other hand, the present invention provides a set of integrated measurements that does. As will be seen, the present invention is a method for management measurements in a PSTS enterprise—particularly one that delivers services on demand.

Cost Accounting is the discipline underlying many prevailing PSTS measures. However, it originated in manufacturing, and even in that context its critics contend it leads to dysfunctional decisions and behavior. Activity-Based Costing is a relatively recent variant. Throughput Accounting is a radical alternative.

As will be seen, the present invention adapts Throughput Accounting for PSTS, but PSTS is so different from manufacturing that the present invention is a substantial departure from previous methods and systems.

Cost Accounting

Cost Accounting (CA) arose in the early 1900s, when labor costs dominated manufacturing and workers were paid by the piece. These factors made it reasonable to allocate overhead to products on the basis of direct labor costs for purposes of preparing financial statements. Yet ever since automation came to dominate manufacturing and workers came to be paid by the hour, allocation of large overhead costs on the basis of small labor costs has created distortions.

When aggregated at the enterprise level, product cost distortions do not affect financial statements. But when CA data is used for product pricing and mix decisions, some products may appear profitable when they in fact are not—and vice versa.

Despite this shortcoming and other significant differences between manufacturing and services, traditional CA says the process for analyzing cost behavior in a services business is almost identical to that for a manufacturing business.

Activity-Based Costing

Activity-Based Costing (ABC) is a relatively recent variant, designed to be a better way to allocate costs. It identifies overhead cost drivers and traces indirect costs to each driver, then determines the percentage of the drivers consumed by each product or service.

For example, material and direct labor are volume-sensitive drivers, while setups and inspections are volume-insensitive drivers. A product sold in small batches requires more setups and inspections, so it gets allocated more overhead. Unfortunately, ABC does not consider that such products may be precisely what customers really want to buy.

ABC is not as prone to product cost distortions as CA, so advocates see it as an improvement. Critics, however, contend it still puts emphasis on product costs rather than customer needs.

Throughput Accounting

Throughput Accounting (TA) is based on the Theory of Constraints (TOC), which gets its name from the principle that just one constraint—one machine type, for instance—generally limits what a manufacturing plant can produce. If non-constraints produce more than the constraint can handle, the difference piles up as additional work-in-process inventory. If non-constraints produce less than the constraint can handle, the difference is output lost by the entire plant. Thus, the way to maximize production while minimizing inventory is to use the constraint to its fullest while moderating use of non-constraints.

Constraints exist in every enterprise, including agriculture, government, education, non-profit organizations, and services businesses. So TOC has applicability far beyond just manufacturing.

TA for manufacturing (TAM) is a radical alternative to CA and ABC because it says allocating overhead is unnecessary. Instead, TAM begins with these financial measures:

Throughput (T) is the rate at which money is generated through sales. It is computed as revenue minus totally variable costs.

Inventory (I) is all money invested in things intended for sale. It includes totally variable costs, such as material, plus things used in production, such as land, machines, trucks, and computers.

Operating Expense (OE) is all money spent turning Inventory into Throughput. It includes direct labor, plus selling, general, and administrative (SG&A) costs.

Thus, TAM does not use labor costs to allocate other operating expenses. And direct labor itself is not treated as a variable cost because workers are not paid by the piece nowadays and enterprises do not adjust their workforce every time demand varies.

The financial measures are used to compute these performance measures:

Net Profit (NP)=T−OE

Return on Investment (ROI)=NP/I

Productivity=T/OE

Turns=T/I

An ideal decision increases T and decreases both I and OE. A good decision increases NP, ROI, Productivity, or Turns.

Under TAM, there are no “product costs.” Instead, there are the following constraint measures:

Throughput per Constraint Unit (T/CU)=(revenue−totally variable cost)/units

Constraint Utilization=time spent producing/time available to produce

Thus, the way to maximize T is to maximize these constraint measures.

For normal product decisions, T/CU is used to determine the mix that maximizes T. If producing less of product A in order to produce more of product B would increase T, for example, that's a good decision. But for major decisions that might shift the constraint or forfeit some T on current products, the following decision-support measure is better:

Change in Net Profit (ΔNP)=ΔT−ΔOE

Maximizing ΔNP ensures that major decisions improve profit across all products. And the following measure shows the impact of investment decisions:

Payback=ΔNP/ΔI

To minimize unfavorable deviations from plans, these control measures should be minimized:

Throughput Dollar Days (TDD)=selling price of late order*days late

Inventory Dollar Days (IDD)=selling price of excess inventory*days unsold

TDD measures something that should have been done but was not: Ship orders on time. IDD measures something that should not have been done but was: Create unnecessary inventory.

TA_{M} is not a substitute for financial reporting according to Generally Accepted Accounting Principles (GAAP), but TA_{M} is an alternative to CA and ABC for management decision-making.

The present invention presents a method and concept referred to herein as Throughput Accounting for Professional, Scientific, and Technical Services (TA_{PSTS}). Like TA_{M}, TA_{PSTS} is not a substitute for financial reporting, but it is an alternative to Cost Accounting (CA) for management decision-making.

Financial Measures for TA_{PSTS}

Financial measures for TA_{PSTS} have a different foundation from TA_{M}, and include the following:

Throughput (T) is the rate of cash generated through deliverables and service levels. It is computed as sales prices minus truly variable costs, such as sales commissions and subcontractor fees.

Deliverables include documents, computer software, computer hardware, data, etc.

Service levels include transactions processed, calls handled, problems resolved, etc.

Investment (I) is all money invested in service production systems, facilities, skills, intellectual capital, and assets—plus money spent on bids and proposals.

Service production systems support project management, resource management, transaction processing, call handling, issue management, collaboration, etc.

Facilities are places from which services are delivered, such as consulting offices, contact centers, data centers, network operations centers, and research laboratories.

Skills are human capital acquired through education, training, mentoring, and experience—and lost through attrition, lack of use, and obsolescence.

Intellectual capital (IC) includes intangibles that enable labor-based revenue generation, such as methodologies, benchmarks, best practices, architectures, etc.

Assets are non-labor based revenue generators, such as software components, patents, and IC that can be licensed apart from labor, such as methodologies and benchmarks.

Bid and proposal (B&P) covers service requirements, client and service provider responsibilities, schedules, prices, and anticipated client benefits.

Operating Expense (OE) is all money spent to produce deliverables and service levels from investments. It is primarily direct labor of partners, managers, and practitioners, but also includes selling, general, and administrative (SG&A) costs.

Delivery is billable labor, plus non-billable labor attributable to a particular project or process (for instance, labor needed to recover a troubled project).

Overhead is everything else—and is entirely non-billable (for instance, sales calls, headquarters functions, and idle resources).

Compared to manufacturers, PSTS enterprises have a higher percentage of truly variable costs if they use subcontractors extensively. Moreover, PSTS enterprises generally must invest a far larger percentage of their revenue in skills, intellectual capital, bids and proposals. Thus, some expenses that would be counted in Operating Expenses for a manufacturing enterprise are instead counted in Total Variable Costs or Investment for a PSTS enterprise.

Like TA_{M}, TA_{PSTS} reverses the typical management priorities from OE, T, I to I, T, OE. This shifts the focus from expenses to profit.

Performance Measures for TA_{PSTS}

The following performance measures apply under TA_{PSTS}:

Net Profit of project or process (NPₚ)=Tₚ−OEₚ

Net Profit of asset (NPₐ)=Tₐ−OEₐ

Net Profit of business unit (NP_{BU})=T_{BU}−OE_{BU}=(ΣTp+'Tₐ)−(OE_{delivery}+OE_{overhead})

Return on Investment of project or process (ROIₚ)=NPₚ/B&Pₚ

Return on Investment of asset (ROIₐ)=NPₐ/Iₐ

Return on Investment of business unit (ROI_{BU})=NP_{BU}/I_{BU}

Productivity of project or process=Tₚ/OEₚ

Productivity of asset=Tₐ/OEₐ

Productivity of business unit=T_{BU}/OE_{BU}

Compared to manufacturers, PSTS enterprises are far more likely to measure the performance of projects performed for clients, business processes performed for clients, assets used to perform such projects and processes, and business units affiliated with a particular profession, science, or technology. Manufacturers, on the other hand, are more likely to measure performance of plants or elements within them, such as an assembly line. Thus, the highly repeatable nature of manufacturing makes the dynamics of its performance fundamentally different from PSTS where virtually every engagement is customized.

OEₚ includes direct labor attributable to the project or process, as well as a proportional allocation of overhead. OEₐ does the same for an asset, though it usually contains more sales and less delivery expense. Since OE_{delivery} comprises the majority of OE_{BU}, the allocation of overhead is not arbitrary. However, if ΣOEₚ+ΣOEₐ is less than OE_{BU}, some overhead is not covered, which thereby reduces NP_{BU}.

Since most investments are used by multiple projects and processes over time, allocating I would be largely arbitrary. B&P, however, can be associated with particular projects and processes, so it's the basis for ROIₚ, even though this doesn't account for all of I. Nevertheless, ROIₚ is useful for deciding which prospective projects and processes warrant B&P, and for later evaluating how effective that decision was. When bids are lost, ROI_{P} is zero, but ROI_{BU} is depressed. When bids are won, ROI_{P} can be positive, negative, or zero, with corresponding effects on ROI_{BU}.

I_{BU} can be funded several ways, including the following:

Cost-plus pricing, the traditional PSTS approach, embeds funding in billing rates.

Utility pricing embeds it in unit prices (e.g., invoices, paychecks, or contacts processed).

Value pricing funds it from a price based on the value the client is expected to receive.

Risk-reward sharing funds it from a price based on the value the client actually receives.

Resource Measures for TA_{PSTS}

Various resource measures apply under TA_{PSTS}, but some only in specific situations:

Totally Variable Cost (TVC)=subcontractor fees, commissions, travel & living, etc.

Throughput per hour (T/h)=(revenue−TVC)/productive hours

Throughput per Constraint Unit (T/CU)=(revenue−TVC)/constrained resources

Operating Expense per hour (OE/h)=(direct labor+SG&A)/available hours

Utilization=time a resource spends producing/time available to produce

Occupancy=time an agent handles contacts and wrap-up/time available for contacts

T/h and T/CU in TA_{PSTS} are similar to T/CU in TA_{M}. However, T/h may apply to all resources, not just constraints, while T/CU always applies just to a resource constraint.

At first glance, T/h may appear to be equivalent to a billing rate, but it is not. For one thing, standard billing rates are planned, while T/h is observed. But the differences go much deeper. The traditional approach to PSTS under cost accounting uses billing rates to price engagements, and billing rates are based on cost rates. Once a year or so, cost rates are set for each skill level via a complicated procedure that boils down to summing the expected costs of the enterprise and divided by the number of expected billable hours. Then billing rates are set for each skill level by adding a target profit margin. Problems with this approach include the following:

Actual costs are usually different from expected costs.

Actual billable hours are usually different from expected hours.

Embedding TVC in cost rates applies it universally instead of selectively.

Prices based on billing rates are driven by costs rather than client value.

Prices based on billing rates are not directly related to what clients are willing to pay.

Consequently, standard rates can make engagements appear more profitable than they really are, or vice versa. And this does not lead to optimization of the enterprise.

T/h avoids all those problems by insisting that prices be based on client value and what clients are willing to pay: That is, by doing utility pricing, value pricing, or risk-reward sharing rather than cost-plus pricing. And in contrast to standard billing rates, which can remain fixed for extended periods, regardless of where the market is going, T/h automatically varies across engagements and over time.

Just as T/h is not a billing rate, OE/h is not a cost rate. An engagement that uses a mix of resources at lower salary bands has lower OE/h, so OE/h also varies across engagements and over time.

Utilization is the percent of time a resource is billable or contributing to investment. For example, training others counts in utilization, but being trained does not. Likewise, administrative time does not count toward utilization, but billable overtime does, even if that overtime is unpaid. Holidays, vacation, and sick days are counted in available time but are not billable, so resources have utilization less than 100%, unless they work billable overtime.

Occupancy is a measure specific to contact centers. An agent is occupied when handling a contact (call or text message) or wrapping up afterward. An agent is not occupied when waiting for a contact—and wait time between contacts is random. A service level around 80% of contacts answered in 20 seconds equates to an occupancy of about 86%. However, as occupancy rises, service level declines dramatically.

Although utilization and occupancy are similar in concept and computation, they are far from identical. Utilization correlates with T (and sometimes I), while occupancy equates to activation. That is, agents who are 86% occupied have 100% utilization for that interval because the agents' time available for contacts is billable, not just the time they're handling contacts.

Constraint measures in TA_{M} is used only on constraints because (1) capacity in manufacturing can often be managed so there's just one constraint and (2) optimizing the constraint optimizes the factory because every non-constraint can be subordinated to the constraint. In contrast, TA_{PSTS} may apply resource measures across all resources because (1) it's often impossible to maintain a single internal constraint in a large PSTS enterprise with diverse engagements and (2) optimizing only constraints will not necessarily optimize a PSTS enterprise because subordination of non-constraints can be extremely difficult.

PSTS engagements are inherently dynamic, so it's generally impossible to maintain a single stable resource constraint for long. Sales may be constrained by solution architects, consulting projects by subject matter experts, business process outsourcing by licensed professionals, information technology projects by IT architects, IT programs by project executives, scientific programs by chief researchers, etc.

Non-constrained resources become prohibitively expensive if they're not billable or contributing to investment for protracted periods.

When a large engagement starts, the need for many resources at once can deplete skill groups that are not usually a constraint; and when a large engagement ends, many resources returning at once for new assignments can create excess even on a constraint.

Client requirements usually change while engagements are underway, which can shift the constraint or create multiple constraints.

The job market may change so that resources that were once scarce become more plentiful, or vice versa.

If resources are available, the constraint on a project is its critical path or critical chain (i.e., tasks with the longest total duration limit when the project can be completed).

If resources are available, the constraint on a business process is often some information technology, such as software, routers, servers, scanners, printers, firewalls, etc.

If the enterprise has sufficient capacity for all the work it can sell, the constraint is external, in the services market.

Client relationships are critical, but non-quantifiable, so marketing and sales are not amenable to optimization quite like services operations are.

Despite this complexity, PSTS resource constraints usually occur in a relatively small number of skill groups. Indeed, most skill groups are rarely, if ever, the constraint because slack resources are available internally or from external sources on short notice via subcontracting. Thus, resource management for PSTS sizes resource buffers based on variability, availability, and criticality of each skill group. A non-zero buffer target provides protective capacity that ensures resource shortages will be small and short.

Although PSTS enterprises have more difficulty than manufacturing or software enterprises when subordinating non-constraints, PSTS enterprises have more flexibility when “elevating” a constraint (increasing its capacity) such that:

Administrative support frees a constrained resource for more-critical tasks.

Delegating tasks to junior resources also frees a constrained resource.

Mentoring up-and-coming individuals can give them vital experience on critical tasks.

Unpaid overtime can be routine on salaried positions.

Procedural alternatives range from “good enough” to “world class.”

Intellectual capital creates resource leverage by reducing labor requirements.

Time-boxed tasks and flexible scope conserve scarce resources.

Decision-Support Measures for TA_{PSTS}

For major decisions, such as which markets to serve and which investments to find, these decision-support measures apply to TA_{PSTS} unchanged from TA_{M}:

Change in Net Profit (ANP)=ΔT−ΔOE

Payback=ΔNP/ΔI

Without a single stable constraint, however, as there generally is in TA_{M}, there is no TA_{PSTS} equivalent to using T/CU to determine the services mix that would maximize T. Sales opportunities are selected for B&P according to many subjective criteria, including technical feasibility, business value, net profit, schedule, odds of winning, risk, market share, client relationship, and strategic fit. Though resource constraints may affect the schedule, they often are not a barrier to PSTS sales because there are so many ways to elevate constraints.

Compared to manufacturing enterprises, decisions based on ΔNP occur far more often in PSTS enterprises. For instance, a typical manufacturing decision based on ΔNP is whether to acquire another firm or make a capital investment, and such decisions occur infrequently. On the other hand, a typical PSTS decision based on ΔNP is whether to start a new practice, start a new line of scientific research, or support a new technology; and these decisions occur frequently.

Control Measures for TA_{PSTS}

To minimize deviations from desired results, these control measures apply in PSTS:

Project Dollars per Day (PDD)=/working days

Process Dollars per Day (PDD)=NP_{process}/working days

Bench Dollars per Day (BDD)=excess resources*working days*OE/resource/day

Project and Process Dollars per Day (PDD) in TA_{PSTS} correspond to Throughput Dollar Days (TDD) in TA_{M} in the sense that all encourage on-time delivery, but “on time” has somewhat different meaning in PSTS. In manufacturing, the production start date may be relevant to suppliers, but customers usually care only about the finish date unless they're involved in the manufacturing process. In PSTS, however, both the engagement start date and finish date are virtually always relevant to clients. One reason is financial: Billing for services is bounded by those dates. A second reason is logistical: The PSTS firm often needs space and equipment at the client site. Another reason is managerial: Clients have their own responsibilities, such as providing resources and oversight. Yet another reason is operational or strategic: Business benefits may begin to flow at any point after engagement start.

In light of such dependencies, a PSTS firm cannot unilaterally change start or finish dates: Date changes must be negotiated with the client. Such negotiations are quite common because changes to scope and duration often occur while PSTS engagements are under way. Therefore, PDD measures “on time” against negotiated duration rather than completion date. If an engagement is late, the numerator decreases and the denominator increases, which shrinks PDD.

PDD quantifies the NP produced each day by projects or processes. In general, the higher the value of PDD, the better. But PDD can be negative if an engagement is unprofitable. PDD is based on NP rather than T to encourage delivery within budget as well as on time. But client satisfaction should also be measured so gains in PDD are not achieved by sacrificing quality.

Whereas manufacturing is in control when TDD is zero, PSTS is in control when PDD is within or rising above its normal range. For example, in a PSTS business with seasonal effects, PDD may be lowest during the 3^{rd} quarter and highest during 4^{th} quarter, but these predictable variations do not mean PDD is out of control unless year-to-year comparisons show deviations.

PDD is defined for both projects and processes so their measures can be combined and compared. There are, however, some subtle differences in how PDD applies to projects versus processes. For example, Project Dollars per Day go up when T increases, OE decreases, or duration decreases. Also, Process Dollars per Day go up only when T increases or OE decreases.

Since business processes are on-going, on-time completion of a process is measured according to the service level agreement (SLA). Chronically completing a process later than the SLA requires usually decreases revenue, or vice versa, which affects the numerator rather than denominator of PDD.

PDD has these features in common across projects and processes:

PDD can measure an individual engagement or a set of engagements. For example, it can cover the current engagement for a given client, no matter when delivered; or it can cover all engagements in a particular business unit, no matter to whom they are delivered.

PDD can measure engagements over their entire duration or just a specific interval of time. For example, average PDD can be computed for all engagements of a specific type, even if they have different durations, or it can be computed for just a particular month.

PDD can measure fully completed, partially completed, or planned engagements so long as the numerator and denominator are consistent. For example, for partially completed engagements, the numerator is NP to date and the denominator is elapsed days to date; or for planned engagements, PDD could just cover a particular quarter next year.

Bench Dollars per Day (BDD) in TA_{PSTS} corresponds to Inventory Dollar Days (IDD) in TA_{M} in the sense that both discourage unnecessary investment in whatever is being sold. BDD quantifies the OE of excess non-billable resources. It goes down when excess resources, non-billable days, or OE per resource per day decrease. Ideally, BDD should be zero, so the definition of “excess resources” is crucial.

For a given skill group, excess resources are measured in relation to the target resource buffer, also known as the “ideal bench level.” The size of the target buffer increases with variability and criticality, but decreases with availability. That is, if about the same number of resources are needed every period, they are never an engagement constraint, and they're readily available from other sources when needed, the target resource buffer can be zero. But if the resource needs range widely, the skill group is a capacity constrained resource, or its resources are not readily available from other sources when needed, the target resource buffer must be greater than zero. Otherwise, the skill group could often become a resource constraint.

Thresholds are set around the target buffer level so normal variation will not trigger hiring or dismissal. It's common for resources to be on the bench briefly between assignments or for the bench to be briefly depleted while resources are returning from assignments, so thresholds keep the resource management process from taking action when capacity will likely stabilize naturally. Excess resources occur only when the actual buffer level rises above the upper threshold. Resources assigned to client engagements or internal projects are never considered part of the buffer, even when taking time out for training, vacation, holiday, or illness.

Having both an upper and lower threshold makes PSTS resource management different from manufacturing, which uses only a lower threshold to trigger inventory replenishment. Nevertheless, TA_{PSTS} uses only the upper threshold for BDD measurement. If the buffer level drops below the lower threshold, nothing happens to BDD because (1) the missing resources may not actually be needed and (2) if the skill group does become a resource constraint that can't be elevated, PDD will decline. Thus, it may be useful to report ΔT for reference.

System Overview for TA_{PSTS}

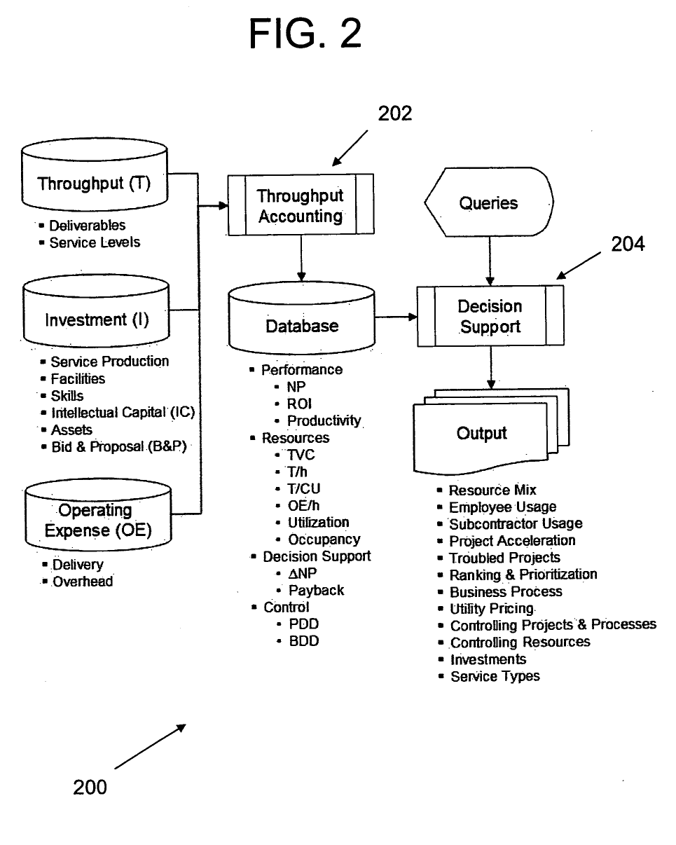

The systemic method described in detail above is graphically represented in FIG. 2 as system 200 for TA_{PSTS}. System 200 includes two subsystems:

The Throughput Accounting subsystem 202 receives T, I, and OE data from various sources, and populates a database with TA_{PSTS} measures as described above.

The Decision Support subsystem 204 generates output based on those TA_{PSTS} measures and thereby supports a variety of management decisions pertinent to Professional, Scientific, and Technical Services.

In many cases, the TA_{PSTS} measures lead to different conclusions than traditional Cost Accounting measures would for reasons explained earlier.

Thus, this system and TA_{PSTS} maintain historical, current, and forecast information. And it produces output in multiple formats and media to support executives, partners, consultants, and staff.

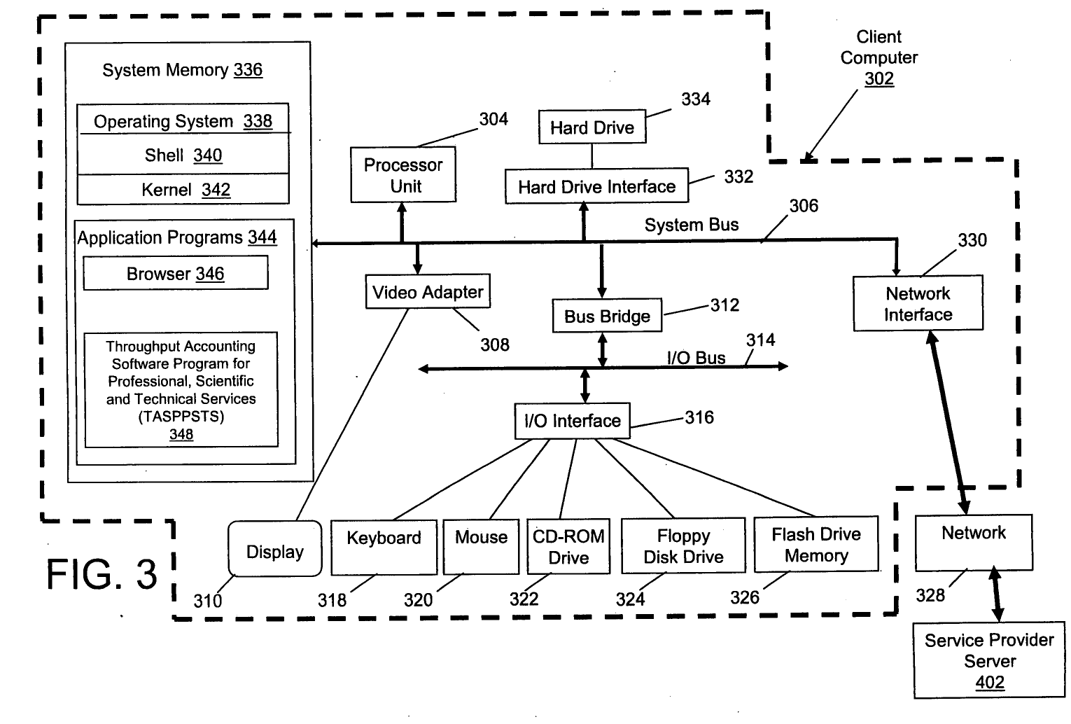

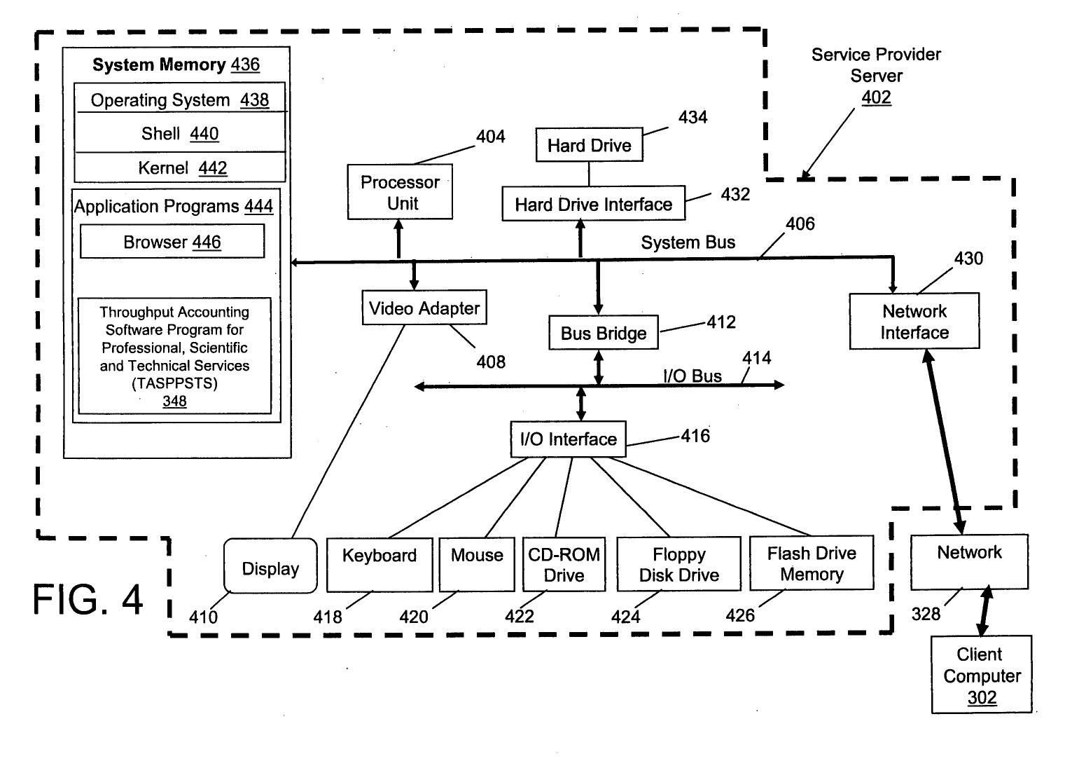

With reference now to FIG. 3, there is depicted a block diagram of an exemplary client computer 302, in which the present invention may be utilized. Client computer 302 includes a processor unit 304 that is coupled to a system bus 306. A video adapter 308, which drives/supports a display 310, is also coupled to system bus 306. System bus 306 is coupled via a bus bridge 312 to an Input/Output (I/O) bus 314. An I/O interface 316 is coupled to I/O bus 314. I/O interface 316 affords communication with various I/O devices, including a keyboard 318, a mouse 320, a Compact Disk—Read Only Memory (CD-ROM) drive 322, a floppy disk drive 324, and a flash drive memory 326. The format of the ports connected to I/O interface 316 may be any known to those skilled in the art of computer architecture, including but not limited to Universal Serial Bus (USB) ports.

Client computer 302 is able to communicate with a service provider server 402 via a network 328 using a network interface 330, which is coupled to system bus 306. Network 328 may be an external network such as the Internet, or an internal network such as an Ethernet or a Virtual Private Network (VPN).

A hard drive interface 332 is also coupled to system bus 306. Hard drive interface 332 interfaces with a hard drive 334. In a preferred embodiment, hard drive 334 populates a system memory 336, which is also coupled to system bus 306. Data that populates system memory 336 includes client computer 302's operating system (OS) 338 and application programs 344.

OS 338 includes a shell 340, for providing transparent user access to resources such as application programs 344. Generally, shell 340 is a program that provides an interpreter and an interface between the user and the operating system. More specifically, shell 340 executes commands that are entered into a command line user interface or from a file. Thus, shell 340 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 342) for processing. Note that while shell 340 is a text-based, line-oriented user interface, the present invention will equally well support other user interface modes, such as graphical, voice, gestural, etc.

As depicted, OS 338 also includes kernel 342, which includes lower levels of functionality for OS 338, including providing essential services required by other parts of OS 338 and application programs 344, including memory management, process and task management, disk management, and mouse and keyboard management.

Application programs 344 include a browser 346. Browser 346 includes program modules and instructions enabling a World Wide Web (WWW) client (i.e., client computer 302) to send and receive network messages to the Internet using HyperText Transfer Protocol (HTTP) messaging, thus enabling communication with service provider server 402.

Application programs 344 in client computer 302's system memory also include a Throughput Accounting Software Program for Professional, Scientific and Technical Services (TASPPSTS) 348. TASPPSTS 348 includes code for implementing the processes described above, including FIG. 2. In one embodiment, client computer 302 is able to download TASPPSTS 348 from service provider server 402.

The hardware elements depicted in client computer 302 are not intended to be exhaustive, but rather are representative to highlight essential components required by the present invention. For instance, client computer 302 may include alternate memory storage devices such as magnetic cassettes, Digital Versatile Disks (DVDs), Bernoulli cartridges, and the like. These and other variations are intended to be within the spirit and scope of the present invention.

As noted above, TASPPSTS 348 can be downloaded to client computer 302 from service provider server 402, shown in exemplary form in FIG. 4. Service provider server 402 includes a processor unit 404 that is coupled to a system bus 406. A video adapter 408 is also coupled to system bus 406. Video adapter 408 drives/supports a display 410. System bus 406 is coupled via a bus bridge 412 to an Input/Output (I/O) bus 414. An I/O interface 416 is coupled to I/O bus 414. I/O interface 416 affords communication with various I/O devices, including a keyboard 418, a mouse 420, a Compact Disk—Read Only Memory (CD-ROM) drive 422, a floppy disk drive 424, and a flash drive memory 426. The format of the ports connected to I/O interface 416 may be any known to those skilled in the art of computer architecture, including but not limited to Universal Serial Bus (USB) ports.

Service provider server 402 is able to communicate with client computer 302 via network 328 using a network interface 430, which is coupled to system bus 406. Access to network 328 allows service provider server 402 to deploy TASPPSTS 348 to client computer 302.

System bus 406 is also coupled to a hard drive interface 432, which interfaces with a hard drive 434. In a preferred embodiment, hard drive 434 populates a system memory 436, which is also coupled to system bus 406. Data that populates system memory 436 includes service provider server 402's operating system 438, which includes a shell 440 and a kernel 442. Shell 440 is incorporated in a higher level operating system layer and utilized for providing transparent user access to resources such as application programs 444, which include a browser 446, and a copy of TASPPSTS 348 described above, which can be deployed to client computer 302.

The hardware elements depicted in service provider server 402 are not intended to be exhaustive, but rather are representative to highlight essential components required by the present invention. For instance, service provider server 402 may include alternate memory storage devices such as flash drives, magnetic cassettes, Digital Versatile Disks (DVDs), Bernoulli cartridges, and the like. These and other variations are intended to be within the spirit and scope of the present invention.

Note further that, in a preferred embodiment of the present invention, service provider server 402 performs all of the functions associated with the present invention (including execution of TASPPSTS 348), thus freeing client computer 302 from having to use its own internal computing resources to execute TASPPSTS 348.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

Software Deployment

As described above, in one embodiment, the process described by the present invention, including the functions of TASPPSTS 348 are performed by service provider server 402. Alternatively, TASPPSTS 348 and the method described herein, including the method shown and described above in FIG. 2, can be deployed as a process software from service provider server 402 to client computer 302. Still more particularly, process software for the method so described may be deployed to service provider server 402 by another service provider server (not shown).

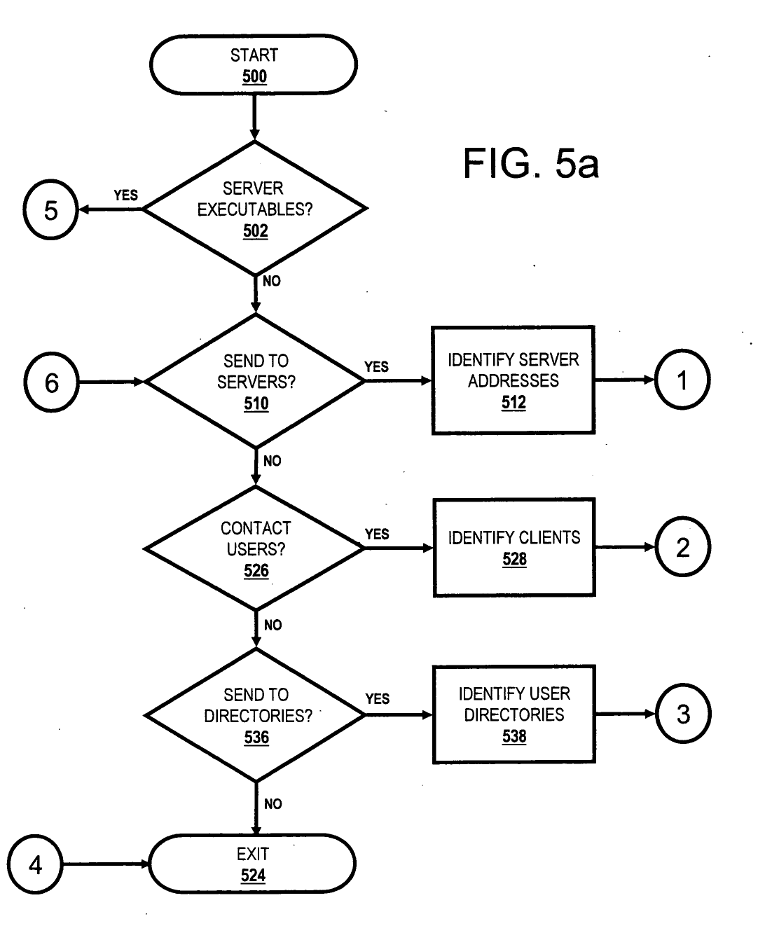

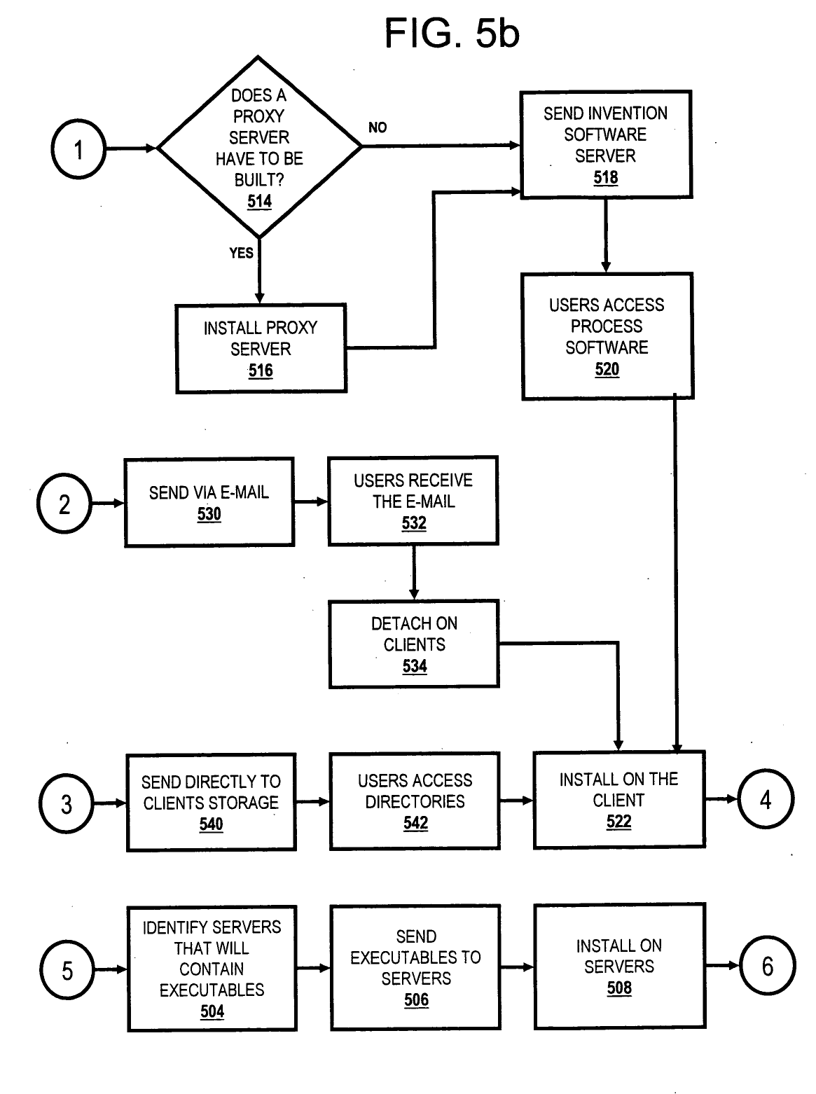

Referring then to FIG. 5, step 500 begins the deployment of the process software. The first thing is to determine if there are any programs that will reside on a server or servers when the process software is executed (query block 502). If this is the case, then the servers that will contain the executables are identified (block 504). The process software for the server or servers is transferred directly to the servers' storage via File Transfer Protocol (FTP) or some other protocol or by copying though the use of a shared file system (block 506). The process software is then installed on the servers (block 508).

Next, a determination is made on whether the process software is to be deployed by having users access the process software on a server or servers (query block 510). If the users are to access the process software on servers, then the server addresses that will store the process software are identified (block 512).

A determination is made if a proxy server is to be built (query block 514) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (block 516). The process software is sent to the servers either via a protocol such as FTP or it is copied directly from the source files to the server files via file sharing (block 518). Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems (block 520). Another embodiment is to have the servers automatically copy the process software to each client and then run the installation program for the process software at each client computer. The user executes the program that installs the process software on his client computer (block 522) then exits the process (terminator block 524).

In query step 526, a determination is made whether the process software is to be deployed by sending the process software to users via e-mail. The set of users where the process software will be deployed are identified together with the addresses of the user client computers (block 528). The process software is sent via e-mail to each of the users' client computers (block 530). The users then receive the e-mail (block 532) and then detach the process software from the e-mail to a directory on their client computers (block 534). The user executes the program that installs the process software on his client computer (block 522) then exits the process (terminator block 524).

Lastly a determination is made on whether to the process software will be sent directly to user directories on their client computers (query block 536). If so, the user directories are identified (block 538). The process software is transferred directly to the user's client computer directory (block 540). This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software (block 542). The user executes the program that installs the process software on his client computer (block 522) and then exits the process (terminator block 524).

VPN Deployment

The present software can be deployed to third parties as part of a service wherein a third party VPN service is offered as a secure deployment vehicle or wherein a VPN is build on-demand as required for a specific deployment.

A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-bee number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a companies multiple fixed sites over a public network such as the Internet.

The process software is transported over the VPN via tunneling which is the process the of placing an entire packet within another packet and sending it over a network. The protocol of the outer packet is understood by the network and both points, called runnel interfaces, where the packet enters and exits the network.

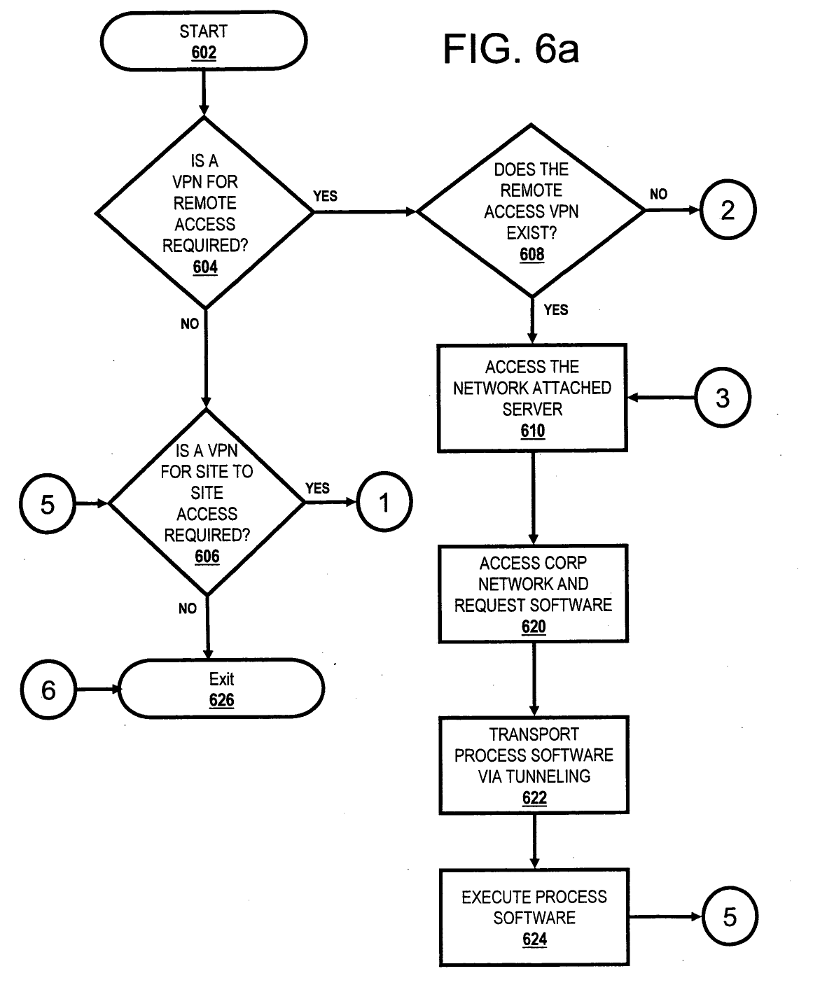

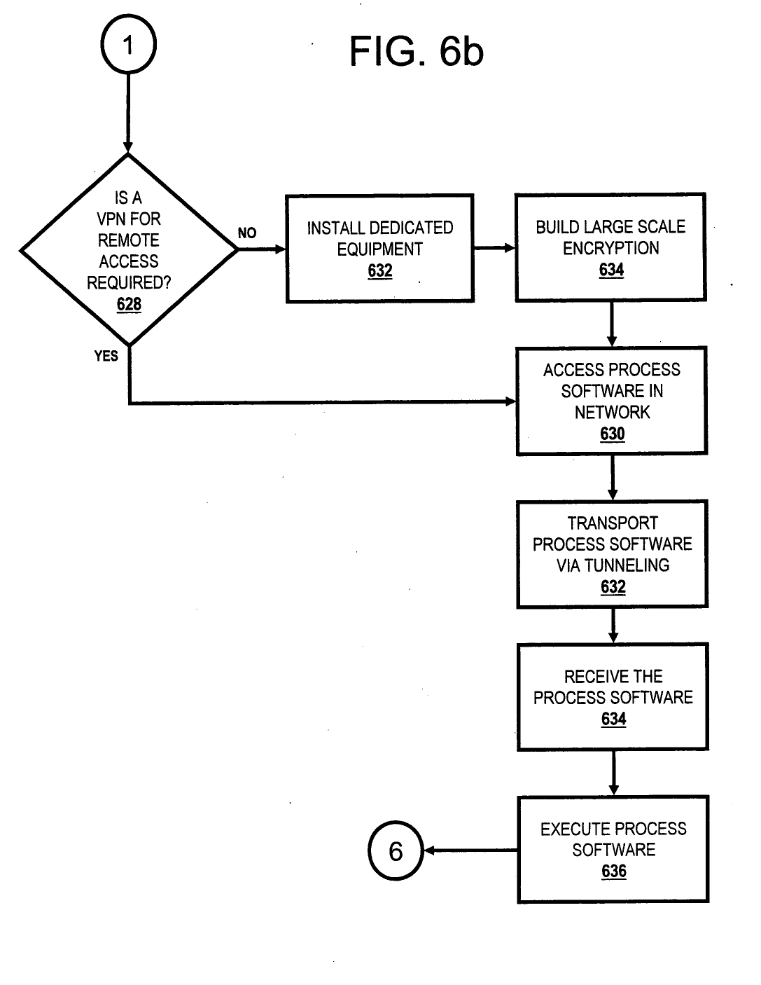

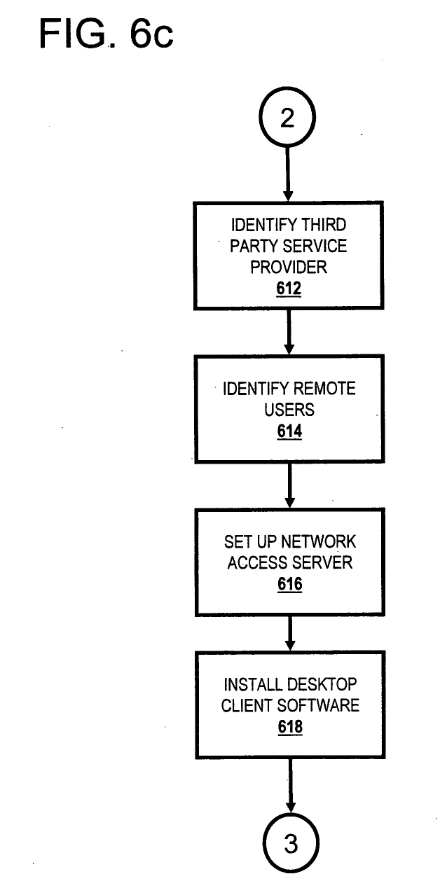

The process for such VPN deployment is described in FIG. 6. Initiator block 602 begins the Virtual Private Network (VPN) process. A determination is made to see if a VPN for remote access is required (query block 604). If it is not required, then proceed to (query block 606). If it is required, then determine if the remote access VPN exists (query block 608).

If a VPN does exist, then proceed to block 610. Otherwise identify a third party provider that will provide the secure, encrypted connections between the company's private network and the company's remote users (block 612). The company's remote users are identified (block 614). The third party provider then sets up a network access server (NAS) (block 616) that allows the remote users to dial a toll free number or attach directly via a broadband modern to access, download and install the desktop client software for the remote-access VPN (block 618).

After the remote access VPN has been built or if it been previously installed, the remote users can access the process software by dialing into the NAS or attaching directly via a cable or DSL modem into the NAS (block 610). This allows entry into the corporate network where the process software is accessed (block 620). The process software is transported to the remote user's desktop over the network via tunneling. That is the process software is divided into packets and each packet including the data and protocol is placed within another packet (block 622). When the process software arrives at the remote user's desk-top, it is removed from the packets, reconstituted and then is executed on the remote users desk-top (block 624).

A determination is then made to see if a VPN for site to site access is required (query block 606). If it is not required, then proceed to exit the process (terminator block 626). Otherwise, determine if the site to site VPN exists (query block 628). If it does exist, then proceed to block 630. Otherwise, install the dedicated equipment required to establish a site to site VPN (block 632). Then build the large scale encryption into the VPN (block 634).

After the site to site VPN has been built or if it had been previously established, the users access the process software via the VPN (block 630). The process software is transported to the site users over the network via tunneling (block 632). That is the process software is divided into packets and each packet including the data and protocol is placed within another packet (block 634). When the process software arrives at the remote user's desktop, it is removed from the packets, reconstituted and is executed on the site users desk-top (block 636). The process then ends at terminator block 626.

Software Integration

The process software which consists code for implementing the process described herein may be integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists matches the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

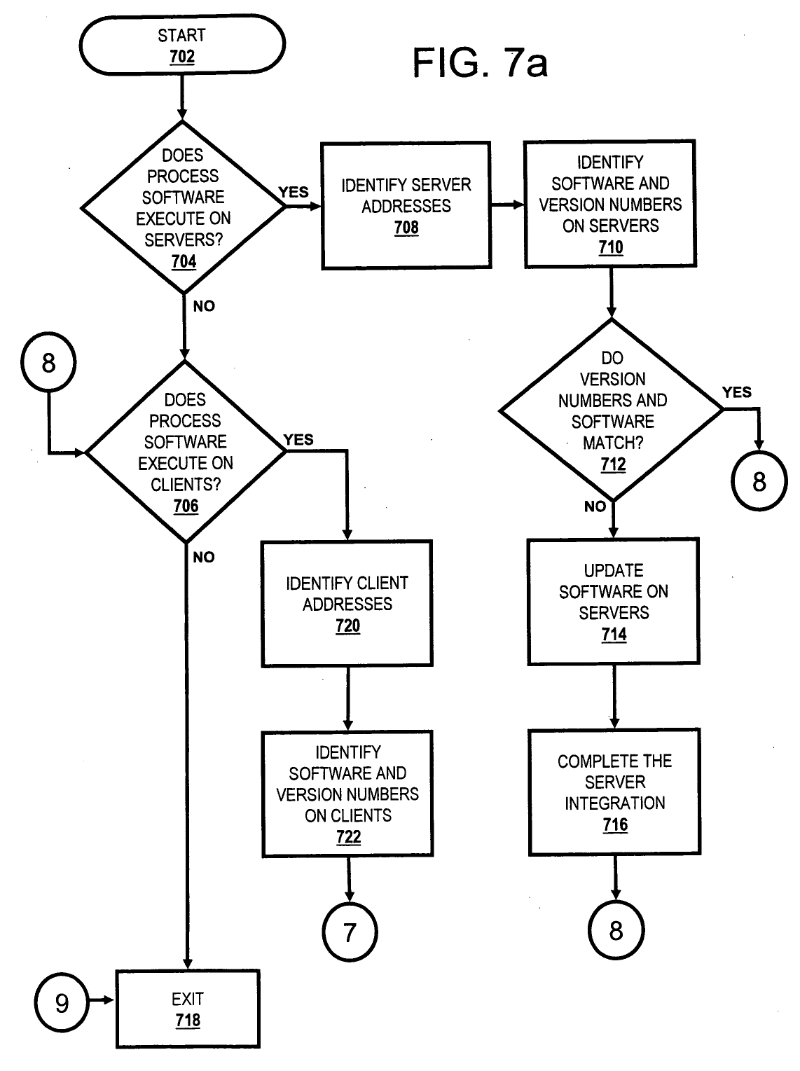

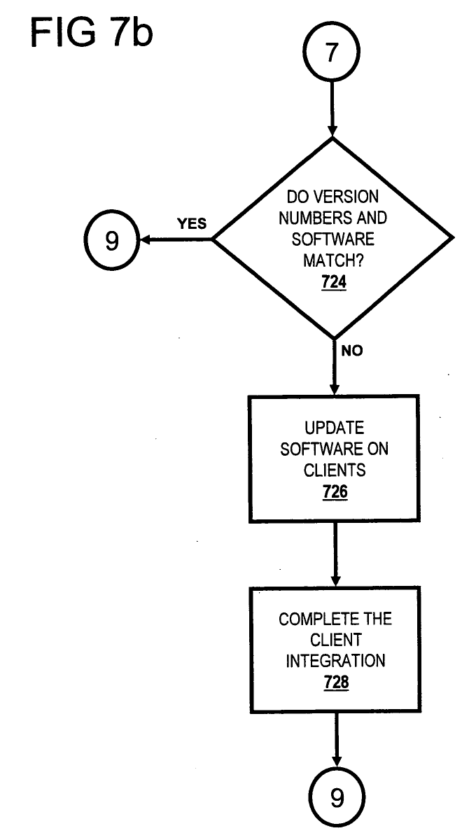

For a high-level description of this process, reference is now made to FIG. 7. Initiator block 702 begins the integration of the process software. The first tiling is to determine if there are any process software programs that will execute on a server or servers (block 704). If this is not the case, then integration proceeds to query block 706. If this is the case, then the server addresses are identified (block 708). The servers are checked to see if they contain software that includes the operating system (OS), applications, and network operating systems (NOS), together with their version numbers, which have been tested with the process software (block 710). The servers are also checked to determine if there is any missing software that is required by the process software in block 710.

A determination is made if the version numbers match the version numbers of OS, applications and NOS that have been tested with the process software (block 712). If all of the versions match and there is no missing required software the integration continues in query block 706.

If one or more of the version numbers do not match, then the unmatched versions are updated on the server or servers with the correct versions (block 714). Additionally, if there is missing required software, then it is updated on the server or servers in the step shown in block 714. The server integration is completed by installing the process software (block 716).

The step shown in query block 706, which follows either the steps shown in block 704, 712 or 716 determines if there are any programs of the process software that will execute on the clients. If no process software programs execute on the clients the integration proceeds to terminator block 718 and exits. If this not the case, then the client addresses are identified as shown in block 720.

The clients are checked to see if they contain software that includes the operating system (OS), applications, and network operating systems (NOS), together with their version numbers, which have been tested with the process software (block 722). The clients are also checked to determine if there is any missing software that is required by the process software in the step described by block 722.

A determination is made is the version numbers match the version numbers of OS, applications and NOS that have been tested with the process software (query block 724). If all of the versions match and there is no missing required software, then the integration proceeds to terminator block 718 and exits.

If one or more of the version numbers do not match, then the unmatched versions are updated on the clients with the correct versions (block 726). In addition, if there is missing required software then it is updated on the clients (also block 726). The client integration is completed by installing the process software on the clients (block 728). The integration proceeds to terminator block 718 and exits.

On Demand

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

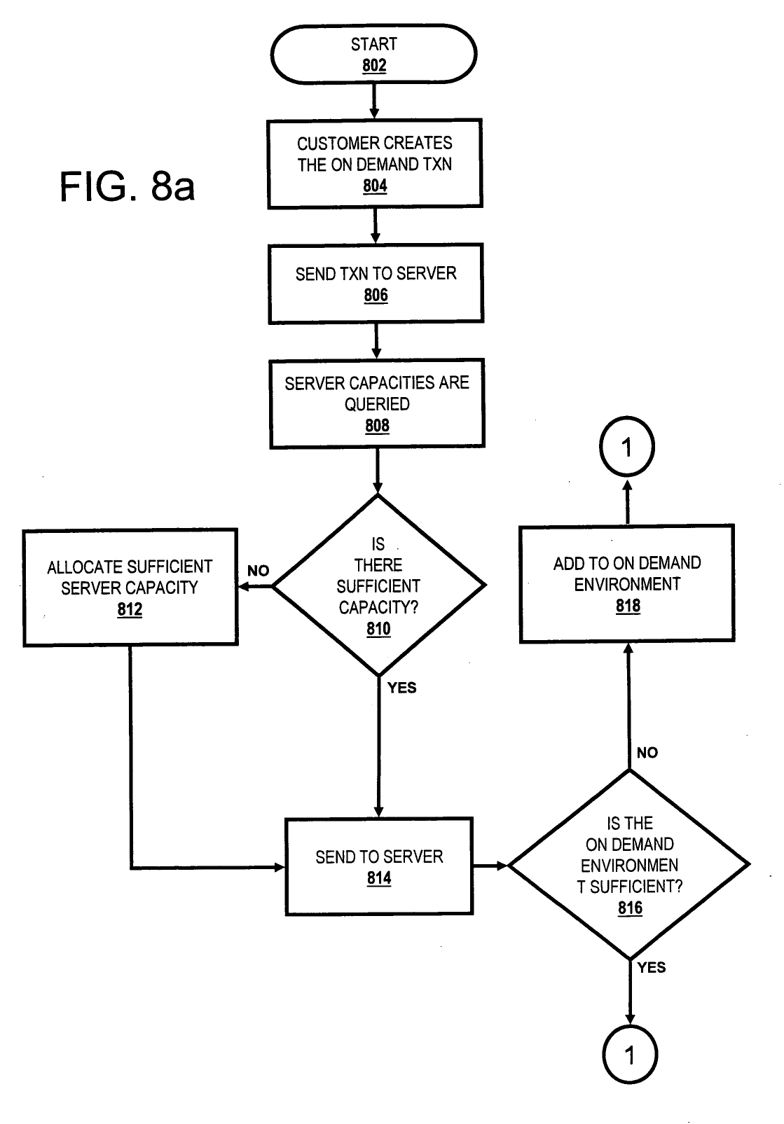

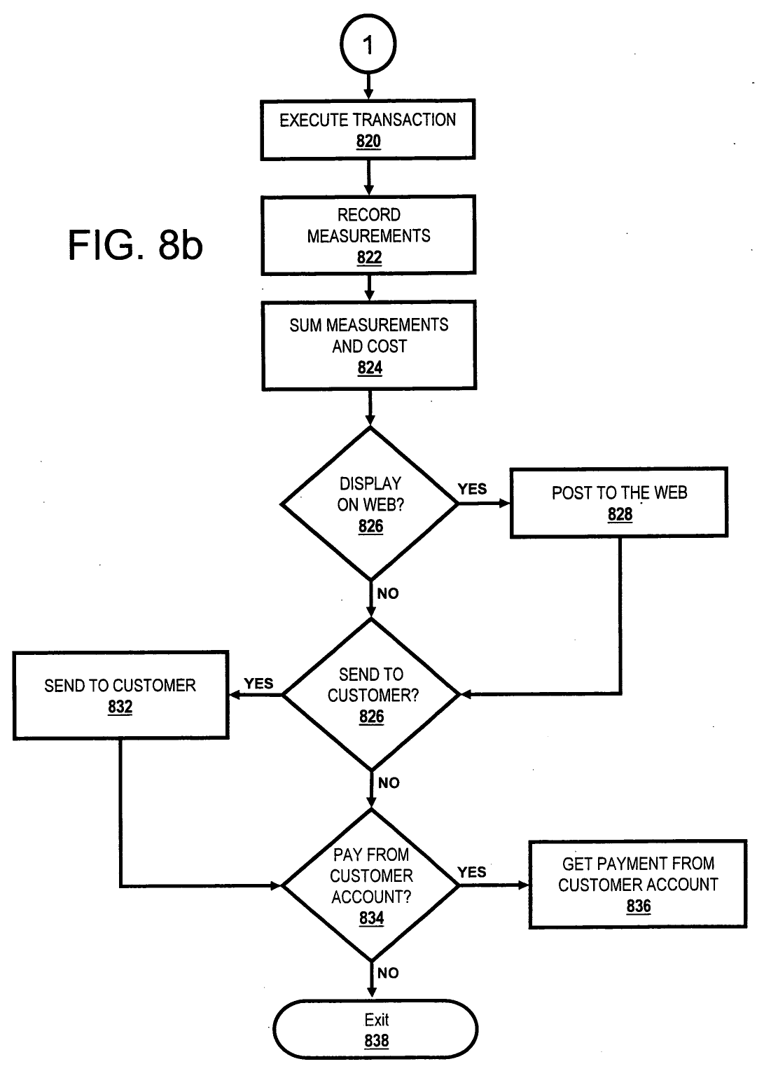

With reference now to FIG. 8, initiator block 802 begins the On Demand process. A transaction is created than contains the unique customer identification, the requested service type and any service parameters that further, specify the type of service (block 804). The transaction is then sent to the main server (block 806). In an On Demand environment the main server can initially be the only server, then as capacity is consumed other servers are added to the On Demand environment.

The server central processing unit (CPU) capacities in the On Demand environment are queried (block 808). The CPU requirement of the transaction is estimated, then the servers available CPU capacity in the On Demand environment are compared to the transaction CPU requirement to see if there is sufficient CPU available capacity in any server to process the transaction (query block 810). If there is not sufficient server CPU available capacity, then additional server CPU capacity is allocated to process the transaction (block 812). If there was already sufficient Available CPU capacity then the transaction is sent to a selected server (block 814).

Before executing the transaction, a check is made of the remaining On Demand environment to determine if the environment has sufficient available capacity for processing the transaction. This environment capacity consists of such things as but not limited to network bandwidth, processor memory, storage etc. (block 816). If there is not sufficient available capacity, then capacity will be added to the On Demand environment (block 818). Next the required software to process the transaction is accessed, loaded into memory, then the transaction is executed (block 820).

The usage measurements are recorded (block 822). The usage measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (block 824).

If the customer has requested that the On Demand costs be posted to a web site (query block 826), then they are posted (block 828). If the customer has requested that the On Demand costs be sent via e-mail to a customer address (query block 830), then these costs are sent to the customer (block 832). If the customer has requested that the On Demand costs be paid directly from a customer account (query block 834), then payment is received directly from the customer account (block 836). The On Demand process is then exited at terminator block 838.

The present invention of Throughput Accounting (TA) for PSTS has many benefits when compared to conventional Cost Accounting (CA) for PSTS, including the following. First, TA maximizes net profit, while CA maximizes resource utilization but not necessarily net profit. Second, TA focuses first on revenue, which is not bounded and can therefore substantially improve net profit, while CA focuses first on cost which is bounded and is therefore limited in its impact on net profit. Third, TA eliminates role conflicts by directing managers' attention to a common goal, while CA creates role conflicts by directing managers' attention to various goals that work at cross-purposes. This listing of benefits is not to be construed as exhaustive, but rather is representative of some of the benefits provided by the present invention in a PSTS environment.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data. Similarly, capitalization and/or lack of capitalization in formulas, and particularly in subscripts and superscripts for symbols in formulas, are not intended to connote any difference in meaning for a same symbol having or not having capitalization.

What is claimed is:

1. A method for management accounting in an enterprise delivering Professional, Scientific, and/or Technical Services (PSTS), the method comprising:
implementing a Throughput Accounting system for a PSTS enterprise, the Throughput Accounting system comprising the steps of:
establishing a set of financial measures for the PSTS enterprise;
establishing a set of performance measures that are based on the financial measures for the PSTS enterprise;
establishing a set of resource measures that are based on resources available to the PSTS enterprise;
creating a set of decision-support measures based on a profitability to the PSTS enterprise; and
minimizing deviations from desired results from the set of decision support measures via a set of control measures.

2. The method of claim 1, wherein the financial measures comprise:
a Throughput (T), said throughput being the rate of cash generated through deliverables and service levels, and is computed as sales price minus truly variable costs;
an Investment (I), said investment being all money invested in service production systems, facilities, skills, Intellectual Capital (IC), assets, and Bids & Proposals (B&P); and
an Operating Expense (OE), said operating expense being all money spent to produce deliverables and service levels from investments, and is computed as billable and non-billable labor plus overhead.

3. The method of claim 2, wherein the performance measures comprise at least one of:
a Net Profit of a Project (NPₚ), wherein NPₚ is equal to a Project Throughput (Tₚ) minus a Project OE (OEₚ);
a Net Profit of an Asset (NPₐ), wherein NPₐ is equal to an Asset Throughput (Tₐ) minus an Asset OE (OEₐ);
a Net Profit of a Business Unit (NP_{BU}), wherein NP_{BU} is equal to a Business Unit Throughput (T_{BU}) minus a Business Unit OE (OE_{BU}), and wherein T_{BU} is equal to (ΣTₚ+ΣTₐ), and wherein OE_{BU} is equal to delivery OE (OE_{delivery}) plus overhead OE (OE_{overhead});
a Return On Investment of a Project (ROIₚ), wherein ROIₚ is equal to NPₚ divided by a Project Bid and Proposal cost (B&Pₚ);
a Return On Investment of an Asset (ROIₐ), wherein ROIₐ is equal to NPₐ divided by an Asset Investment (Iₐ);
a Return On Investment of a Business Unit (ROI_{BU}), wherein ROI_{BU} is equal to NP_{BU} divided by a Business Unit Investment (I_{BU});
a Productivity of a Project, wherein the Productivity of a Project is defined as Tₚ divided by OEₚ;
a Productivity of an Asset, wherein the Productivity of an Asset is defined as Tₐ divided by OEₐ; and
a Productivity of a Business Unit, wherein the Productivity of a Business Unit is defined as T_{BU} divided by OE_{BU}.

4. The method of claim 2, wherein the resource measures comprise at least one of:
a Totally Variable Cost (TVC), wherein the TVC includes variable costs associated with a project;
a Throughput per hour (T/h), wherein T/h is equal to (revenue−TVC)/productive hours associated with the project;
a Throughput per Constraint Unit (T/CU), wherein T/CU is equal to (revenue−TVC) divided by constrained resources; and
an Operating Expense per hour (OE/h), wherein OE/h is equal to (direct labor costs for the project plus allocated overhead costs) divided by available hours.

5. The method of claim 2, wherein the decision-support measures comprise at least one of:
a Change in Net Profit (ΔNP), wherein ΔNP is equal to a change in Throughput (ΔT) minus a change in Operating Expenses (ΔOE); and
a Payback, wherein Payback is equal to ΔNP divided by a change in Investment (ΔI).

6. The method of claim 2, wherein the control measures comprise at least one of:
a Project Dollars per Day (ProjectDD), wherein ProjectDD is equal to project net profit (NP_{profit}) divided by a number of working days available to a project;
a Process Dollars per Day (ProcessDD), wherein ProcessDD is equal to a process net profit (NP_{process}) divided by a number of working days available to a process; and
a Bench Dollars per Day (BDD), wherein BDD is equal to excess resources times working days times OE/resource/day.

7. A method comprising:
inputting a Throughput (T), an Investment (I) and an Operating Expense (OE) for a Professional, Scientific, and/or Technical Services (PSTS) enterprise into a Throughput Accounting logic to create performance measures, resource measures, decision support measures and control measures;
storing the performance measures, resource measures, decision support measures and control measures in a database; and
inputting queries and contents of the database into a decision support logic to create a supported decisions output.

8. The method of claim 7, wherein the Throughput comprises:
deliverables for the PSTS enterprise; and
service levels for the PSTS enterprise.

9. The method of claim 7, wherein the Investment comprises, for the PSTS enterprise, at least one of a cost of:
service production;
facilities;
skill training;
Intellectual Capital (IC);
assets; and
Bid and Proposal (B&P) for a project.

10. The method of claim 7, wherein the Operating Expense comprises, for the PSTS enterprise, at least one of a cost of:
delivery of a product; and
overhead associated with the product.

11. The method of claim 7, wherein the performance measures comprise at least one of:
a Net Profit of a Project (NPₚ), wherein NPₚ is equal to a Project Throughput (Tₚ) minus a Project OE (OEₚ);
a Net Profit of an Asset (NPₐ), wherein NPₐ is equal to an Asset Throughput (Tₐ) minus an Asset OE (OEₐ);
a Net Profit of a Business Unit (NP_{BU}), wherein NP_{BU} is equal to a Business Unit Throughput (T_{BU}) minus a Business Unit OE (OE_{BU}), and wherein T_{BU} is equal to (ΣTₚ+ΣTₐ), and wherein OE_{BU} is equal to deliver OE (OE_{delivery}) plus overhead OE (OE_{overhead});
a Return On Investment of a Project (ROIₚ), wherein ROIₚ is equal to NPₚ divided by a Project Bid and Proposal cost (B&Pₚ);
a Return On Investment of an Asset (ROIₐ), wherein ROIₐ is equal to NPₐ divided by an Asset Investment (Iₐ);
a Return On Investment of a Business Unit (ROI_{BU}), wherein ROI_{BU} is equal to NP_{BU} divided by a business unit investment (I_{BU});
a Productivity of a Project, wherein the Productivity of a Project is defined as Tₚ divided by OEₚ;
a Productivity of an Asset, wherein the Productivity of an Asset is defined as Tₐ divided by OEₐ; and
a Productivity of a Business Unit, wherein the Productivity of a Business Unit is defined as T_{BU} divided by OE_{BU}.

12. The method of claim 7, wherein the resource measures comprise at least one of:
a Totally Variable Cost (TVC), wherein the TVC is includes variable costs associated with a project;
a Throughput per hour (T/h), wherein T/h is equal to (revenue−TVC)/productive hours associated with the project;
a Throughput per Constraint Unit (T/CU), wherein T/CU is equal to (revenue−TVC) divided by constrained resources;
an Operating Expense per hour (OE/h), wherein OE/h is equal to (direct labor costs for the project plus allocated overhead costs) divided by available hours;
a Utilization, wherein the utilization is equal to time that a resource spends producing divided by time available to the resource to produce; and
an Occupancy, wherein the occupancy is equal to time that an agent handles contacts and wrap-up divided by time available for contacts.

13. The method of claim 7, wherein the decision-support measures comprise:
a Change in Net Profit (ΔNP), wherein ΔNP is equal to a change in Throughput (ΔT) minus a change in Operating Expenses (ΔOE); and
a Payback, wherein Payback is equal to ΔNP divided by a change in Investment (ΔI).

14. The method of claim 7, wherein the control measures comprise at least one of:
a Project Dollars per Day (ProjectDD), wherein ProjectDD is equal to project net profit (NP_{profit}) divided by a number of working days available to a project;
a Process Dollars per Day (ProcessDD), wherein ProcessDD is equal to a process net profit (NP_{process}) divided by a number of working days available to a process; and
a Bench Dollars per Day (BDD), wherein BDD is equal to excess resources times working days times OE/resource/day.

15. The method of claim 7, wherein the supported decisions output comprises at least one of:
a Resource mix;
an Employee usage;
a Subcontractor usage;
a Project acceleration;
a list of Troubled projects;
a Ranking and prioritization of projects;
a Business process associated with the project;
a Utility pricing for the project;
a list of Controlling projects and processes;
a list of Controlling resources;
a list of Investments; and
a list of Service types.

16. A computer-usable medium embodying computer program code, the computer program code comprising computer executable instructions configured to:
implement a throughput accounting system for a Professional, Scientific, and/or Technical Services (PSTS) enterprise, the throughput accounting system comprising the steps of:
establishing a set of financial measures for the PSTS enterprise;
establishing a set of performance measures that are based on the financial measures for the PSTS enterprise;
establishing a set of resource measures that are based on resources available to the PSTS enterprise;
creating a set of decision-support measures based on a profitability to the PSTS enterprise; and
minimizing deviations from desired results from the set of decision support measures via a set of control measures.

17. The computer-useable medium of claim 16, wherein the financial measures comprise:
a Throughput (T), said Throughput being the rate of cash generated through deliverables and service levels, and is computed as sales price minus truly variable costs;
an Investment (I), said Investment being all money invested in service production systems, facilities, skills, intellectual capital (IC), assets, and bids & proposals (B&P); and
an Operating Expense (OE), said Operating Expense being all money spent to produce deliverables and service levels from Investments, and is computed as billable and non-billable labor plus overhead.

18. The computer-useable medium of claim 16, wherein the performance measures comprise at least one of:
a Net Profit of a Project (NPₚ), wherein NPₚ is equal to a Project Throughput (Tₚ) minus a Project OE (OEₚ);
a Net Profit of an Asset (NPₐ), wherein NPₐ is equal to an Asset Throughput (Tₐ) minus an Asset OE (OEₐ);
a Net Profit of a Business Unit (NP_{BU}), wherein NP_{BU} is equal to a Business Unit Throughput (T_{BU}) minus a Business Unit OE (OE_{BU}), and wherein T_{BU} is equal to (ΣTₚ+ΣTₐ), and wherein OE_{BU} is equal to a delivery OE (OE_{delivery}) plus an overhead OE (OE_{overhead});
a Return On Investment of a Project (ROIₚ), wherein ROIₚ is equal to NPₚ divided by a Project Bid and Proposal cost (B&Pₚ);
a Return On Investment of an Asset (ROIₐ), wherein ROIₐ is equal to NPₐ divided by an Asset Investment (Iₐ);
a Return On Investment of a Business Unit (ROI_{BU}), wherein ROI_{BU} is equal to NP_{BU} divided by a business unit investment (I_{BU});
a Productivity of a Project, wherein the Productivity of a Project is defined as Tₚ divided by OEₚ;
a Productivity of an Asset, wherein the Productivity of an Asset is defined as Tₐ divided by OEₐ; and
a Productivity of a Business Unit, wherein the Productivity of a Business Unit is defined as T_{BU} divided by OE_{BU}.

19. The computer-useable medium of claim 16, wherein the computer program code is deployed to a client computer from a server at a remote location.

20. The computer-useable medium of claim 16, wherein the computer program code is provided by a service provider to a customer on an on-demand basis.
